(19) United States
(12) Patent Application Publication
(10) Pub. No.: US 2010/0183123 A1
(43) Pub. Date: Jul. 22, 2010

(54) RADIOGRAPHY CASSETTE AND SUBSTRATE FOR THE OPENING AND CLOSING OPERATIONS OF SUCH A CASSETTE

(76) Inventors: Christian Thiery, Paris (FR); Jean-Paul Negre, Bonnelles (FR)

Correspondence Address: BRINKS HOFER GILSON & LIONE, P.O. BOX 10395, CHICAGO, IL, 60610, US

(21) Appl. No.: 12/669,312

(22) PCT Filed: Jul. 16, 2008
(86) PCT No.: PCT/FR08/01043

§ 371 Date: Jan. 15, 2010

(51) Int. Cl. G03B 42/04

(52) U.S. Cl. 378/187; 378/182

(57) ABSTRACT

A radiography cassette capable of receiving at least one X-ray or Gamma radiation detector includes a front frame with a front wall through which a radiation to be detected can passand a rear frame with a rear wall, where the front and rear frames define an inner section of the cassette. A discontinuous foam layer is provided between the location for receiving the detector and the rear wall, where the discontinuous foam layer is formed by a plurality of studs oriented perpendicularly to the front and rear walls and distributed in the inner section of the cassette, so as to be able to be laterally deformed on the crushing thereof under pressure. A temporary fixation means is provided for maintaining the cassette in a closed configuration or for opening the same.

### PRIORITY CLAIM

This application is a nationalization under 35 U.S.C. 371 of PCT Application No. PCT/FR2008/001043, filed Jul. 16, 2008, which claims priority to French Patent Application No. 0756655, filed Jul. 20, 2007, and incorporated by reference herein.

### TECHNICAL FIELD

The present invention concerns a cassette intended to receive films and/or screens for X-ray or gamma-ray imaging. This cassette can be employed to detect X-rays and gamma-rays with different energies. It can be equipped with various passive plane detectors such as memory radioluminescent screens or argentic films whether or not associated with reinforcing screens.

The invention is applied to the following fields: non-destructive testing, physical measurements, X-ray or gamma-ray imaging and any ionizing radiation imaging technique.

### BACKGROUND

Cassettes intended to contain films and reinforcing screens have been used in the field of medical imaging for many years. Various designs have been patented. The designs most commonly encountered consist of thin metal walls and a hinged door type closure with locking clips. Identical or very similar designs are used in the field of non-destructive testing.

One aspect of such a cassette is that of being light-tight after it has been closed. This is assured by chicanes and seals possibly associated with an anti-reflection treatment of the surfaces. However, systems using hinges are not always reliable over time and in the end become slack because of wear. These deformations make frequent renewal of the cassettes obligatory.

Another aspect is reducing absorption by the front face of the cassette (facing the radiography source) and the radiation diffused by the latter. One solution to this problem is to use a material that is highly transparent to the radiation. This can be Bakelite, for example (U.S. Pat. No. 3,191,032), carbon fiber or composite material (U.S. Pat. No. 4,638,501). For large cassettes it is however difficult to produce a front face of low absorption and sufficient mechanical stiffness for the films and the screens to remain pressed together.

Another fundamental aspect of these cassettes is holding the films and the screens in close contact over the whole of their surface. The slightest gap leads to a loss of spatial resolution. In the case of a scintillation type reinforcing screen the light emitted by the screen is divergent and the greater the gap between the screen and the film the more the light is dispersed before reaching the film. This results in a degraded image of lower spatial resolution. In the case of a metal screen in contact with a radiosensitive screen, the secondary electron showers produced by the interaction with the metal screen are also divergent. A gap between the screens therefore encourages spreading of the information and deterioration of the spatial resolution.

Various solutions have been proposed for pressing the screens and the films together correctly. The simplest are based on mechanical springs (U.S. Pat. No. 3,482,097, GB Patent No. 840 007, for example) but the pressure exerted is neither well controlled nor homogeneous, which can cause the quality of the images to deteriorate because the films are pressure-sensitive.

Other, more sophisticated devices use preformed elastic plates to provide a more homogeneous pressure (U.S. Pat. No. 5,388,140 and European Patent No. EP 0 632 319, GB Patent No. 1 219 612). A plate, generally a metal plate, is manufactured with a domed shape and a thickness such that, once pressed against the stack, it applies a predetermined pressure. However, these cassettes are designed for only one thickness of screens and films. Moreover, when inserting a stack of screens and films, the latter are clamped progressively from one edge and can slide one on the other. It is therefore difficult to ensure accurate placing of said stack. Finally, the slightest defect of flatness of the rigid plate or the preformed plate leads to localized poor contact.

One system (U.S. Pat. No. 3,860,826) uses air pressure to press the screens and films together. The drawbacks of this device are having to provide a source of compressed air and that manipulating the cassette is more complicated because of the pneumatic connections. Another technique widely used employs flexible pockets into which the screens and films are introduced. An orifice is then used to evacuate the pocket. Atmospheric pressure presses the films and screens together. Difficult to apply to large formats (30×40 cm for example), this technique also has the drawback of being ill suited to stacks and provides no means of geometrically registering a film (or screen) with another or a film (or screen) with the exterior.

The most recent systems for compressing the stack of screens and films include placing an elastic foam between the bottom of the cassette and the stack, the function of this foam being to maintain the contact between the various layers (U.S. Pat. No. 4,637,043, U.S. Pat. No. Re 35,284, U.S. Pat. No, 5,912,944). This foam is often covered with a more rigid film having a smooth and homogeneous contact surface. However, these devices do not always guarantee good contact between the films and the screens because of defects in the flatness of the front face of the cassette or the foam or even of the rigid film deposited on the foam. Localized gaps appear and spatial resolution is degraded. This is all the more sensitive as the plate area increases and aging of the foams and contact surfaces leads to loss of elasticity and permanent deformation.

### SUMMARY

The invention aims to overcome the aforementioned drawbacks by proposing a cassette suitable for producing X-ray or gamma-ray ionizing radiation images of high spatial resolution in a wide energy band from a few tens of keV to a few tens of MeV or more. To this end, the invention aims in particular to provide placement of screens and films against each other in the cassette without gaps, at the same time as remaining as compatible as possible with a low overall weight.

The invention also aims to provide a cassette able to contain a detection cell made up interchangeably of a standard argentic film, with or without reinforcing screens, a memory radioluminescent screen, with or without metal screens, or any other plane passive radiation detectors, being adaptable to various dimensions and formats and to various thicknesses.

The invention further aims to provide a cassette for producing stacks (of up to approximately twenty detection cells as defined above) to obtain multiple detections of the same radiant image, for example to allow combination of cells of different types (memory radioluminescent screens, films,and the like) and different sensitivities to increase the detection dynamic, to enhance the visualization of certain mass per unit area gradients in areas of interest of the object, to introduce intermediate filters to target certain energy levels of the radiant image or to multiply detected images to improve by numerical addition thereof the signal to noise ratio of the image and thus the quantum efficiency of detection.

To this end the invention proposes a radiography cassette adapted to house at least one X-ray or gamma-ray detector, including:

a front frame carrying a front wall adapted to have radiation to be detected pass through it,

a rear frame carrying a rear wall, these frames defining an internal section of the cassette,

a discontinuous layer of foam disposed between the location provided for the detector and the rear wall, this discontinuous layer of foam being formed of a plurality of pads oriented perpendicularly to the front and rear walls and distributed within the internal section of the cassette, and

temporary fixing elements for allowing holding the cassette in the closed configuration or opening it.

Thus one aspect of the invention teaches using independent foam pads to press the screens and the films together. As indicated above, in the existing technologies, to prevent localized gaps between the films and the screens, many systems have proposed to exert a continuous pressure over the whole of the area of the screens and the films. This continuous and homogeneous pressure was usually applied by springs or a foam mat of continuous and constant thickness. In these systems, and for large films and screens, the localized pressure exerted can become excessive in some areas, leading to deformation of the front face of the cassette, at the same time as remaining insufficient in other areas, which in all cases is reflected by poor pressing of the screens against each other despite the pressure exerted. This degrades spatial resolution.

The concept proposed by the invention therefore dispenses with continuous pressure over all of the area of the screens and the films in favor of localized pads. This novel configuration provides better control of the pressure exerted locally by offering more scope for adjustment and improved distribution of forces, in particular because the pads can be deformed laterally.

According to other aspects of the invention or advantageous features of the invention, where applicable combined:

the pads are each fixed to a continuous sheet of foam situated between the pads and the location provided for the detector, which in particular facilitates manipulation when mounting the pads inside the cassette, as well as clearly defining the location intended to receive the detection cells (or other sensitive layers),

the pads are produced in foams of lower density than the foam sheet, which combines stiffness because of the continuity of the sheet of greater density and fine adjustment of the pressure because of the low density of the pads,

the pads are evenly distributed inside this internal section, which amounts to stating that the pads are disposed in a regular array; the pads are preferably arranged in an array formed of rows and columns parallel to the sides of the frames (in practice the length and the width of the internal section of the cassette),

the pads have a length representing between ¼ and ½ of their greatest width, which makes them solid enough to prevent them leaning in a lateral direction,

the pads have a distance between their centers representing between 150% and 300% of their greatest width, which corresponds to good filling of the space at the same time as benefiting from the discontinuous effect of the pads,

the pads have, parallel to the front and rear walls, a circular section, which corresponds to shapes (cylindrical or frustoconical] that are easy to produce;

the front wall is formed of a lightweight composite material, in practice a composite fabric including a plurality of mats coated with resin,

the temporary fixing elements each include a screw and a nut each adapted to be carried by a respective one of the frames so as to allow separation of the frames at each of the locations of these temporary fixing elements; there is therefore no hinge providing a continuous connection between the frames when the cassette is in the open configuration; the screw is advantageously provided with a ring so that it is captive on one of the frames whereas the nut is an insert fixed relative to the other frame,

the frames have on their surfaces adapted to come face to face complementary shapes forming chicanes parallel to the periphery of the frames,

the frames have on their respective surfaces adapted to come face to face complementary pegs and housings disposed at locations that are asymmetrical with respect to the center of the cassette so as to constitute polarizing members,

it further includes an intermediate frame adapted to be interleaved between the front and rear frames,

notches are produced in line with each other in the edges of the same side of each of the frames at a position that is offset relative to the center on this side so as to constitute a polarizer element on positioning the cassette in a housing.

Another aspect of the invention proposes a support for operations of opening and closing a cassette of the aforementioned type, characterized in that it includes two series of pegs each of which is adapted to receive in a unique configuration each of the front and rear frames.

Each series preferably includes a peg adapted to penetrate into a notch provided on the edge of the cassette.

Thus the presence of pads can be complemented by a dedicated rigid front face transparent to the radiation and a novel closure system based on two independent frames allowing the addition, if necessary, of intermediate frames with the aim of adapting the cassette to different thicknesses of the stack of cells used. This intermediate frame advantageously reproduces the chicanes of the frames intended to be radiation-tight. Finally, a dedicated support and an associated filling procedure make the placement of detection cells in the cassette more secure.

### BRIEF DESCRIPTION OF THE DRAWINGS

Objects, features and advantages of the invention emerge from the following description, given by way of nonlimiting illustration, with reference to the appended drawings, in which:

FIG. 1 is an exploded view of a cassette of the invention in section taken along the line A-A in FIG. 2,

FIG. 2 is a plan view of it, facing the rear frame,

FIG. 3 is a side view of it, as seen from the bottom in FIG. 2, partially cut away and in section taken along the line B-B in FIG. 2,

FIG. 4 is an enlarged view of the left-hand part of FIG. 3,

FIG. 5 is a perspective view of the cassette as seen from the rear,

FIG. 6 is a side view of another foam-based intermediate layer consisting of 48 pads usable in the cassette from FIGS. 1 to 5 instead of the intermediate layer with 63 pads,

FIG. 7 is a top view of the intermediate layer from FIG. 6,

FIG. 8 is a perspective view of a support for the operations of opening/closing a cassette of the invention,

FIG. 9 is a view of this support after placing a closed cassette in it, and

FIG. 10 is a view of this support after opening this cassette.

### DETAILED DESCRIPTION

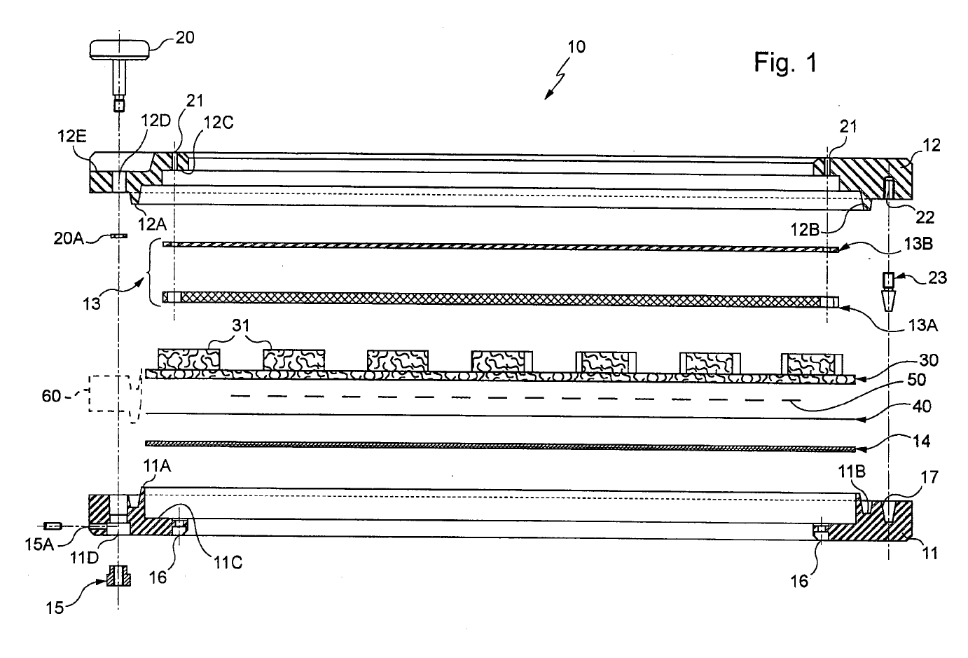

FIGS. 1 to 5 represent, as an example of one embodiment of the invention, a radiography cassette 10 for X-ray or gamma-ray ionizing radiation including a cassette body and internal components, in greater or lesser number according to requirements.

Cassette Body

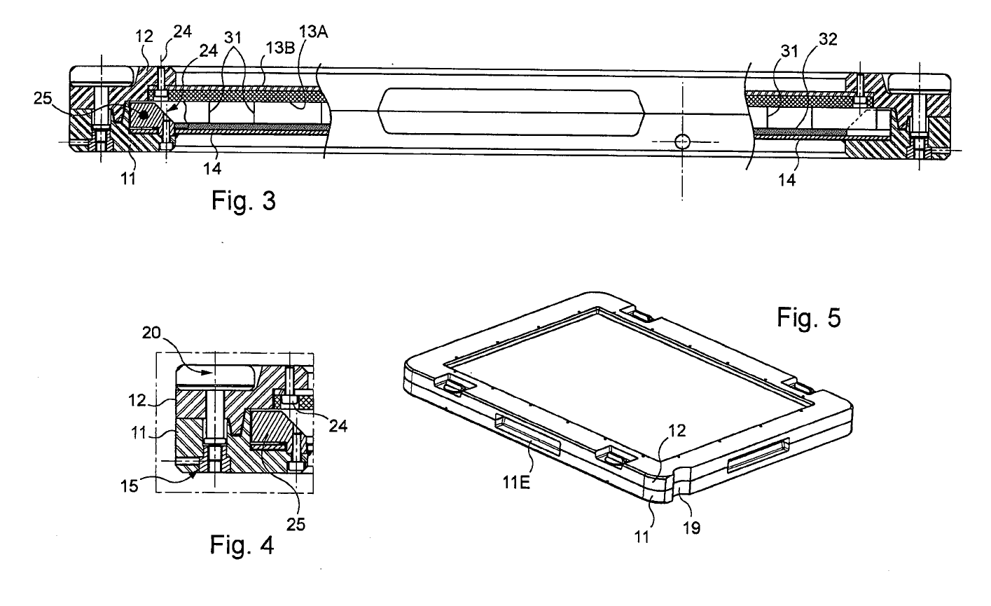

The cassette body consists of a front frame 11 (in the lower portion of FIG. 1 or FIG. 3), a rear frame 12 (in the upper portion), a rear wall 13 and a front wall 14. The front frame and the front wall are intended to face the incident radiation, while the rear frame and the rear wall are intended to face away from the incident radiation.

The frames 11 and 12 advantageously include, along an opening provided in each of them, respective ribs 11A and 12A intended to be housed one alongside the other in a corresponding groove 11B of the frame 11 or along an internal edge 12B of the frame 12, so as to form a chicane adapted to minimize the risk of penetration of light or radiation into the cassette via the interface between these frames when they are placed one against the other, i.e. when the cassette is closed.

These frames further include, at the periphery of their openings, rims 110 and 12C adapted to hold the aforementioned front or rear wall 13 or 14 in place when the cassette is closed.

These frames further include openings adapted to receive various components for securing the assembled frames to each other.

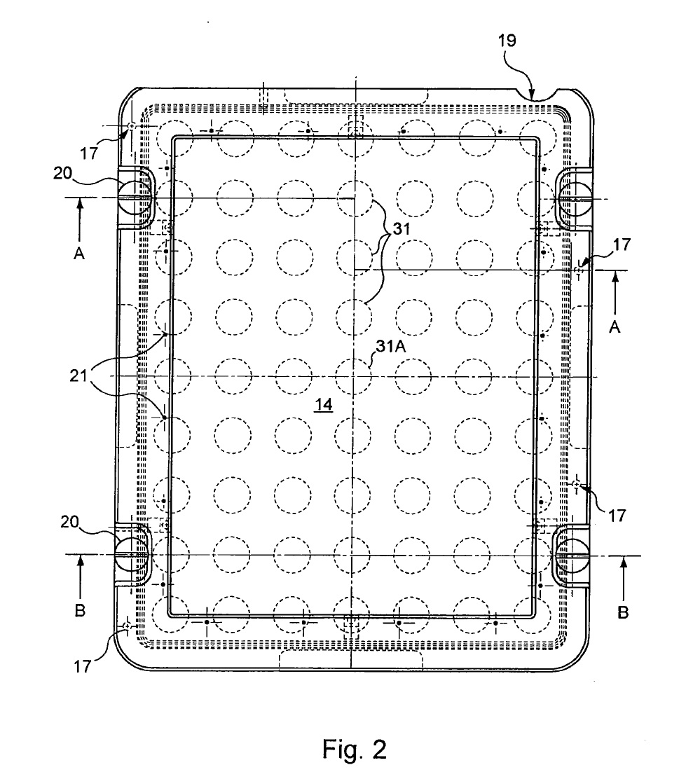

Thus in the example shown the front frame 11 includes in its left-hand portion a hole 11D having, starting from the exterior (and thus from the bottom in FIG. 1), a maximum diameter, a minimum diameter and then an intermediate diameter; this hole is intended to receive an insert 15 that is positioned in the frame 11 by a transverse screw (not represented in FIG. 1) passing through a hole 15A opening into the hole 11D. This frame 11 also includes holes 16 intended to receive clamping screws 24 (see FIGS. 3 and 4) for holding the front wall 14 in place. Finally, the frame 11 also includes (see the right-hand portion of FIG. 1) housings 17, frustoconical here, the function of which will become apparent hereinafter. As emerges from FIG. 2, in the example represented there are four blind holes 17 at asymmetrical locations relative to the center of the cassette (this does not rule out these blind holes being disposed symmetrically, to the right and to the left, with respect to a plane of symmetry that is horizontal in FIG. 2.

As emerges from FIG. 5, the front frame 11 and the rear frame 12 further include, near their surfaces intended to come face to face, recesses 11E (here machined rectangular recesses) intended to facilitate insertion of a finger by the operator to separate the frames when the cassette is closed. Here there is a recess 11E in the middle of each side of these frames.

Facing the hole 11D of the front chassis, the chassis 12 includes a rear hole 12D opening into a recess 12E; this rear hole is intended to receive the shank of a screw 20 the head of which is intended to be accommodated in the recess 12E and the tip of which is intended to cooperate with the insert 15 of the frame 11 so as to hold the frames together when the cassette is closed. The configurations of the screw and of a ring 20A engaged in a groove of the tip at the end opposite the head relative to the frame 12 are such that they conjointly form what is known as a captive screw. This captive screw is intended to cooperate with the inset to close the cassette.

This rear frame 12 also includes holes 21, analogous to the holes 16 of the frame 11, intended to receive screws for fixing the rear wall of the cassette (see reference 24 in FIGS. 3 and 4).

This frame also includes in its edge a notch 19 (here a machined half-cylinder) adapted to line up with the notch formed in the edge of the frame 11.

This frame further includes as many blind holes 22 (cylindrical holes here) as there are blind holes 17 in the first frame, disposed facing those blind holes 17. The cylindrical blind holes 22 are intended to receive the body of polarizer (or indexing) pins 23 the tip of which is adapted to be received in a corresponding frustoconical blind hole 17.

Here this rear wall 13 of the cassette consists of two plates each assuming one function of this rear wall, namely here a perspex plate 13A and an aluminum alloy plate 13B, or plates of any other pair of materials that are light, stiff and diffuse very little the radiation concerned; more generally this means a low-density plastic material plate and a metal plate. The thickness of the rear face is sufficient to maintain good flatness when the cassette is closed and for the content of the cassette to be compressed and to block scattered radiation reflected onto the rear of the cassette by the environment. The thickness of the perspex (or altuglas) plate is sufficient to stop secondary electrons back-scattered by the metal rear face. The typical thickness of the plates 13A and 13B, taken together, is a few millimeters for a cassette receiving 30×40 cm2 films.

Here the plates 13A and 13B have holes adapted to receive fixing screws 24 adapted to cooperate with the orifices 21 of the frame 12 (see FIGS. 3 or 4).

The front wall 14 is advantageously independent; as indicated above, it is through this wall that radiation reaches the interior of the cassette.

It is advantageously a composite plate, formed of a composite fabric stiffened by an epoxy resin. A typical construction is as follows:

one layer of transparent vinylester gel coat,

three balanced 200 g/m2 carbon mats,

Araldite 3505 epoxy encapsulating resin and 3405 hardener,

one layer of transparent vinylester gel coat.

This composite material offers good transparency and good homogeneity to ionizing radiation, even when exposed at low energies (a few tens of keV to a few hundred keV) at the same time as guaranteeing sufficient stiffness. A thickness of 2 to 3 mm is typically used for a cassette receiving 30×40 cm2 detection cells.

Blocks 25 are advantageously distributed along the frame 11; their principal function is to guide the film when it is put into place. Thanks to their bevel cut (steep chamfer), the operator does not have to position the film precisely in the cassette: the film naturally finds its own position (tolerance of plus or minus 1 cm in all directions). These blocks, of which there are six here, advantageously have the auxiliary function of cooperating with the screws 24 to fix the front wall 14 to the front frame 11 (see FIGS. 3 and 4). It should be noted that these guides are intentionally small to prevent scattering (which implies minimizing the material added in the proximity of the film).

Of course, one of these blocks can have a different geometry to the other blocks, so as to serve as a polarizer when positioning this set of films/screens. These blocks can also be replaced by a continuous internal subframe running along the internal edge of the front frame for positioning the films/screens all around their periphery. The blocks 25 for positioning the radiosensitive cells are advantageously replaced by a single positioning subframe that is easier to raise using an intermediate subframe and/or the intermediate frame. The subframe is preferred to individual blocks in the case of high stacking of detection cells.

Once assembled, the two frames constitute, with the front and rear walls, a chicane guaranteeing total blocking of light. An antireflective treatment can be applied to the internal parts of the components to prevent any conduction of light by successive reflections along the interfaces between the frames if a very high level of light proofing is necessary.

Internal Components of the Cassette

The body of the cassette can contain more or fewer films, screens or other plates between the front and rear walls. In the example shown, there are two of these internal components, namely a discontinuous layer of foam 30 and a filter 40. Of course, in use, this cassette further contains at least one sensitive layer (or detection cell) the location of which is diagrammatically represented by the dashed line 50.

This optional filter 40, intended to be situated between the first detection cell (not represented in the figures) and the front face 14 can be added with the object of filtering certain unwanted low-energy radiation. This filter is advantageously made of tantalum in order to limit its thickness. It serves also as a signal reinforcing screen (it produces electrons in addition to the radiation passing through it) for radiation energies greater than 200 keV.

The discontinuous foam layer 30 consists of a plurality of pads 31, which here are cylindrical and regularly spaced. In a variant that is not shown the pads can be distributed in a heterogeneous way, for example more densely in the central portion than at the periphery, or vice-versa, according to the requirements of the user and as a function of optimization test results carried out on a given cassette structure with a given geometry.

These pads 31 are preferably stuck to a continuous plane support film 32 of foam with a higher density than that of the pads 31 while the free surfaces of the pads 31 (oriented upward in FIG. 1) are stuck to the internal face of the rear wall 13 of the cassette (here to the plate 13A). As a result, the foam support plane 32 is in contact with the rear face of the last film or screen contained in the cassette.

The advantage of such a set of pads is to distribute evenly the pressures on the multilayer stack constituting the front wall 14 of the cassette and thus to ensure perfect pressing of the films and screens onto the whole of the surface of this front wall. It can in fact be assumed that the fact that the pads are separate allows them to be crushed, when they are placed under pressure, and enables a precise pressure to be applied against the front wall of the cassette, thanks to the possibility of these pads being deformed laterally.

The nature of the foams used, the dimensions (thickness and diameter), and the number of pads can be modified as a function of the dimensions of the receiver, the number of films and screens, their weight, etc. It will be evident to the person skilled in the art how to make such choices.

In one particular 30×40 cm2 cassette, the pads are of polyurethane polyether foam with a density of 15 kg/m3, their diameter is 30 mm, and their thickness is 10 mm. They are laid out on a regular grid with a pitch of 50 millimeters. The support is of polyurethane polyether foam with a density of 20 kg/m3, of thickness equal to 4 mm.

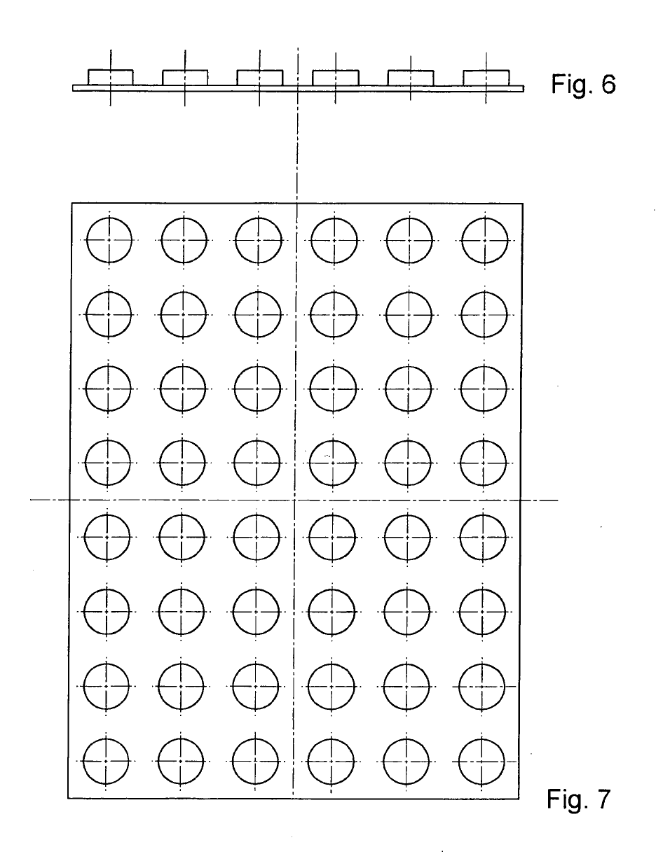

As indicated above, the distribution of the pads can vary according to requirements. Thus in particular the foam layer 30 from FIGS. 1 to 5 includes an odd number of pads (here 63), with a central pad 31A (the array of pads is 7 pads wide by 9 pads long), but it is obviously possible to adopt an even number of pads in length and in width; thus FIGS. 6 and 7 represent a variant forming a 6×8 matrix.

Similarly, it is possible for the pads to have various geometries, cylindrical as in the figures, or frustoconical, of circular section (as shown) or elongate (either radially or circumferentially).

Finally, although in the example considered here the pads are all produced with the same geometry and in the same material, there can be variations in material and geometry from one pad to another. Giving the pads different heights according to their location, and according to requirements, can also be envisaged.

It is therefore clear that, because the aim is to achieve pressing of the films or screens (at the location 50) against the front wall 14 over the whole of their surfaces, it was entirely natural in the prior art solutions to think of using continuous pressurizing layers, but that choosing, in accordance with the invention, a plurality of pads has no negative effect on the homogeneity of placement but, to the contrary, means that an accurate pressure can be applied at all points by varying the density, shape and distribution of the various pads.

In the example considered here, only the layers 30 and 40 are provided to complement the sensitive layer at the location 50.

If, given requirements, additional layers are to be provided and/or the sensitive layer must be particularly thick, the fact that the two frames are independent, with no hinged connection as in various prior art solutions, has the advantage of enabling the use of an intermediate frame 60 shown diagrammatically in FIG. 1, an upper portion of which is configured like the upper portion of the front (lower) frame 11, so as to be able to cooperate with the rear (upper) frame 12 in the same way as the frame 11, and the lower portion of which is configured like the lower portion of the rear frame 12, so as to be able to cooperate with the front frame 11 in the same way as that frame 12. The thickness of this intermediate frame defines the additional distance that it is possible to add between the front and rear walls of the cassette. Intermediate frames of various thicknesses could naturally be provided, depending on requirements. The presence of the chicanes at each interface guarantees good isolation, at least in relation to light, whilst in conjunction with the polarizer pins 23 guaranteeing good lateral positioning of each frame relative to the next or the previous frame.

Clearly intermediate frames (or subframes) enable the cassette to be adapted to stacks of cells of a number of thicknesses (internal elements of the cassette or sensitive layers). These subframes are advantageously produced in the same material as the frames 11 and 12, i.e. in aluminum or any other light and strong material. They are sandwiched between the two frames. For reasons of light-tightness, they reproduce the chicane profiles of the frames. Their thickness is adapted to the thickness of the stacks used. In practice, a user must introduce a subframe or change the subframe each time that the thickness of the stack is increased by more than 3 mm. The intermediate subframes are advantageously screwed to the front frame (by any appropriate additional means) so that there is no risk of them moving during an operation of opening/closing the cassette. They can thus be equipped with four threaded holes for closing the cassette with the captive wide-head screws 20 (which thus no longer cooperate with the inserts 15) or provided with open holes for use with longer captive screws adapted to cooperate with said inserts 15.

### Closure System

It follows from the foregoing description that here the cassette is closed by a set of four wide-head screws 20 that are captive (thanks to fitting retaining rings 20A) but allow complete separation of the frames. This closure function is provided in combination with the polarizer pins 23.

The size of the screws is sufficient for it to be possible to tighten them by hand.

Polarizer System and Filling Procedure

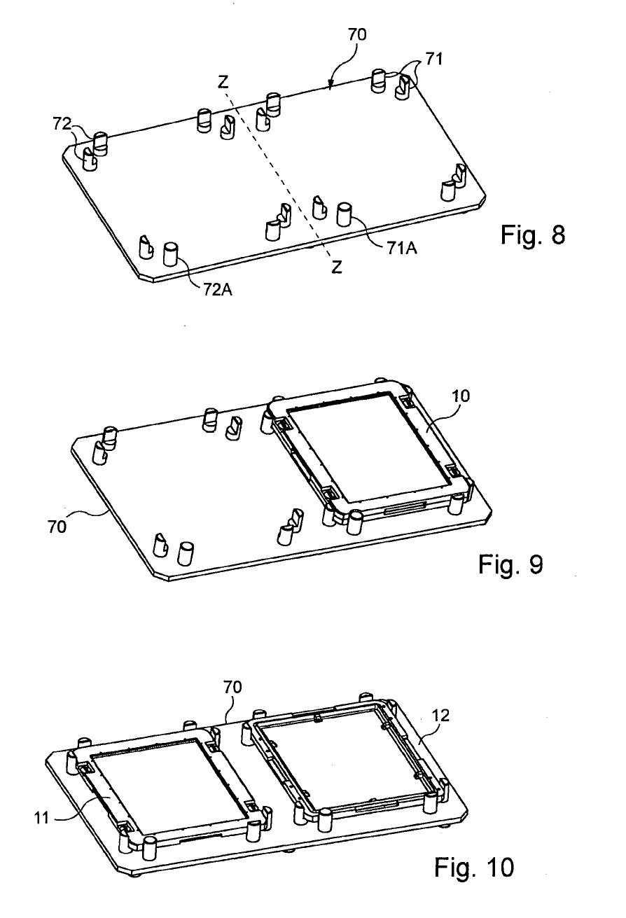

To allow unambiguous positioning of films and screens (or sensitive cells) in darkness, a simple and reliable positioning procedure employs a support 70 (see FIGS. 8 to 10) designed to receive the components of the body of the cassette during handling.

This further guarantees that the sensitive cells will not be prestressed or deformed.

As emerges from FIG. 8, this dedicated support includes two series of pegs 71 and 72 symmetrically disposed with respect to a line of symmetry Z-Z. These pegs are configured to locate each frame from below and at the sides. In practice there are two pegs at each corner of the frames and most of them are of generally cylindrical shape, with a cut-out defining a bearing corner for the periphery of a frame (the horizontal parts of these corners are coplanar while the vertical parts of these corners are adapted to the length of the periphery of a frame): nevertheless, one of these pegs, denoted 71A in the right-hand series and 72A in the left-hand series, has no such cut-out, providing a polarizing function when placing a cassette through cooperation with the notches 19 of each of the frames 11 and 12.

Such a support 70 enables reliable placement and removal of cells in a darkroom, and thus in a situation of reduced operator vision, thanks to a sequence for loading and unloading films of the following type:

Place the cassette on the jig: the orientation and the direction (captive screws 20 facing the operator) are ensured by the cut-outs 19 on the cassette and by the polarizer cylinders 71A or 72A of the support 70. The cassette will rock if not placed correctly, which the operator will not fail to realize, despite the darkness (see FIG. 9). Thus only one position is possible on the series of pegs 71 or on the series of pegs 72.

Open the cassette: unscrew the screws 20, pick up the upper assembly (by the integral handles provided by virtue of the recesses 11E) and put down this upper assembly on the right (or on the left, depending on the original placement). As in the preceding step, only one position is possible (see FIG. 10).

Load or unload the cells (by hand)

Close the cassette: take up the upper assembly, offer it up to the lower assembly and allow to slide. The conical polarizer pins 23 guide the assembly to its exact position.

Screw in the captive screws.

Clearly the preferred version of the invention described hereinafter combines a number of advantages:

the superposition of the screens and the films is without gaps, thanks to the pressure exerted by the foam pads,

because of its structure, the cassette can be robust and rigid thanks to an appropriate choice of the materials used,

the cassette is light-tight because of its chicane system,

the dimensions and the thickness of the cassette can be modified in a modular manner, in particular through the possibility of interleaving intermediate frames,

the cassette is adapted to receive different receivers, films with and without reinforcing screens, or memory radioluminescent screens (with and without metal screens), in particular because of the aforementioned modular feature,

the cassette allows stacking of a number of cells of screen-film pairs or memory radioluminescent screens,

positioning the films and screens in the cassette is easy and reliable thanks to the presence of the polarizers and the loading procedure,

the cassette is nevertheless easy to open and close, despite the absence of a permanent connection between the frames, and offers long-term performance in terms of configuration retention (no hinge, but use of captive screws).

1. A radiography cassette adapted to house at least one X-ray or gamma-ray detector, the cassette comprising:
a front frame carrying a front wall adapted to detect radiation that passes through front wall;
a rear frame carrying a rear wall, wherein the front and rear frames define an internal section of the cassette;
a discontinuous layer of foam disposed between a location provided for the detector and the rear wall, the discontinuous layer of foam comprising a plurality of pads oriented perpendicularly to the front and rear walls and distributed within the internal section of the cassette such that the pads deform laterally when they are crushed under pressure; and
temporary fixing elements configured to hold the cassette in a closed configuration or allow the cassette to be opened.

2. The cassette according to claim 1, wherein the pads are each fixed to a continuous sheet comprising foam, and wherein the continuous sheet is situated between the pads and the location provided for the detector.

3. The cassette according to claim 2, wherein the pads comprise foam having a lower density than the foam of the continuous sheet.

4. The cassette according to claim 1, wherein the pads are evenly distributed inside the internal section.

5. The cassette according to claim 4, wherein the pads are arranged in an array of rows and columns parallel to the sides of the frames.

6. The cassette according to claims 1, wherein the pads have a length corresponding to ¼ and to ½ of a greatest pad width.

7. The cassette according to 1 6, wherein the pads are arranged in spaced relationship such that a distance between centers corresponds to 150% to 300% of a greatest pad width.

8. The cassette according to claim 1, wherein the pads have a circular section parallel to the front and rear walls.

9. The cassette according to claim 1, wherein the front wall comprises a composite fabric including a plurality of mats coated with resin.

10. The cassette according to claim 1, wherein the temporary fixing elements each include a screw and a nut each adapted to be carried by a respective one of the front and rear frames so as to allow separation of the frames at the locations of the temporary fixing elements.

11. The cassette according to claim 10, wherein the screw is provided with a ring so that it is captive on one of the front or rear frames and the nut comprises an insert fixed relative to the other frame.

12. The cassette according to claim 1, wherein the front and rear frames have surfaces adapted to come face to face with complementary shapes forming chicanes parallel to the periphery of the front and rear frames.

13. The cassette according to claim 1, wherein the front and rear frames have surfaces adapted to come face to face with complementary pegs and housings disposed at locations that are asymmetrical with respect to a center of the cassette so as to constitute polarizing members.

14. The cassette according to claim 1, further comprising an intermediate frame interleaved between the front and rear frames and creating modules in the internal volume of the cassette.

15. The cassette according to claim 1, further comprising notches in line with each other in edges of a side of each of the front and rear frames at a position offset relative to the center of the side so as to constitute a polarizer element upon positioning the cassette in a housing.

16. A support for opening and closing a cassette according to claim 1, comprising two series of pegs each adapted to receive in a unique configuration of the front and rear frames, respectively.

17. The support according to claim 16, wherein each series of pegs includes a peg adapted to insert into a notch on an edge of the cassette.
